(19) United States
(12) Patent Application Publication
(10) Pub. No.: US 2015/0122668 A1
(43) Pub. Date: May 7, 2015

(54) Apparatuses and Methods for Conditioning Water, and Systems and Processes Incorporating Same

(71) Applicant: Wood Stone Corporation, Bellingham, WA (US)

(72) Inventor: Tadeusz Karabin, Bellingham, WA (US)

(21) Appl. No.: 14/528,700

(22) Filed: Oct. 30, 2014

Related U.S. Application Data
(60) Provisional application No. 61/899,026, filed on Nov. 1, 2013.

(51) Int. Cl. C02F 1/46; C02F 1/461

(52) U.S. Cl. CPC C02F 1/4602; C02F 1/46176; C02F 2201/46115
USPC 205/750; 205/746; 204/263; 204/257

(57) ABSTRACT

A water conditioner that utilizes ionic flow and selective ionic filtering to control water hardness and/or pH. In some embodiments, the water conditioner includes one or more conditioning cells each having electrodes and a cathode side and an anode side separated by an ion-selective filter. The ion-selective filter is design/configured/selected to pass alkaline earth metal cations and block corresponding carbonate anions. When the electrodes are energized and water is present on the cathode and anode sides of the filter membrane, the alkaline earth metal cations pass from the anode side to the cathode side through the membrane, while the membrane blocks carbonate ions on the cathode side from passing to the anode side. In this manner, alkaline earth metal cations, and water hardness, can be reduced in the anode flow.

### RELATED APPLICATION DATA

This application claims the benefit of priority of U.S. Provisional Patent Application Ser. No. 61/899,026, filed on Nov. 1, 2013, and titled “Membrane Water Conditioner,” which is incorporated by reference herein in its entirety.

### FIELD OF THE INVENTION

The present invention generally relates to the field of water conditioning. In particular, the present invention is directed to apparatuses and methods for conditioning water, and systems and processes incorporating same.

### BACKGROUND

Water is essential to many human activities, including generating electrical power via steam and water turbines, heating and humidifying living spaces, bathing, cooking, making beverages, and washing and removing wrinkles from clothing, to name just a few. Water for use in these and other activities varies in chemical composition, such as hardness, depending on the source of the water. In a number of geographic locations, especially where water is obtained from aquifers high in calcium and magnesium (such as limestone, chalk, and dolomite), the water is high in carbonate hardness, or temporary hardness, that is typically caused by the presence of dissolved calcium carbonate and magnesium carbonate. Water that is high in carbonate hardness is undesirable to use in many human activities because the alkaline earth metal(s), for example, calcium and/or magnesium, precipitate out of the water and, over time, form mineral scale on surfaces exposed to the water. Such scale has a variety of detrimental effects, including reducing volumetric capacities (possibly leading to clogging), reducing heat-transfer efficiencies, reducing wicking ability, and diminishing electrical characteristics, among others. Where carbonate hardness is prevalent and one or more of the detrimental effects of scale lead to unacceptably accelerated equipment failure, such as, for example, in boilers, water heaters, and humidifiers, the water is often softened using ion exchange resins in which calcium cations are replaced with 2+ charges with twice the number of mono-cations, such as sodium or potassium. A drawback of ion exchange softening is that the water contains higher levels of the mono-cations than existed prior to the softening.

### SUMMARY OF THE DISCLOSURE

In one implementation, the present disclosure is directed to a method of conditioning water containing alkaline earth metal cations and corresponding carbonate anions. The method includes flowing the water into a first conditioning cell having a first cathode side and a first anode side so as to provide, respectively, a cathode flow and an anode flow; inducing the alkaline earth metal cations in the anode flow toward the first cathode side; permitting the alkaline earth metal cations in the anode flow to pass to the cathode flow; and inhibiting the carbonate anions in the cathode flow from passing to the anode flow.

In another implementation, an apparatus for conditioning water containing alkaline earth metal cations and carbonate anions. The apparatus includes a first conditioning cell that includes a first cathode side; a first anode side; a first cathode located on the first cathode side; a first anode located on the first anode side; a first inlet designed and configured to receive the water and to provide the water to both the first cathode side and the first anode side to provide, respectively, a cathode flow and an anode flow; a first cathode outlet designed and configured to allow the cathode flow to exit the first cathode side; a first anode outlet designed and configured to allow the anode flow to exit the first anode side; and a first ion-selective filter membrane separating the cathode flow and anode flow from one another, the first ion-selective filter membrane designed/configured/selected to, when the water is present: permit the alkaline earth metal cations in the anode flow to pass to the cathode flow; and inhibit the carbonate anions in the cathode flow from passing to the anode flow.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagrammatic view of a single-cell water-conditioning apparatus made in accordance with the present invention and that includes a single conditioning cell;

FIG. 2 is an enlarged longitudinal cross-sectional view as taken along line 2-2 of FIG. 1;

FIG. 3 is a schematic diagram of a three-cell water-conditioning apparatus made in accordance with the present invention;

FIG. 4 is a schematic diagram of another three-cell water-conditioning apparatus made in accordance with the present invention;

FIG. 5 is a graph of solubility of CaCO₃ and Ca(OH)₂ in water versus pH; and

FIG. 6 is a diagrammatic view of an exemplary system and process that includes a water-conditioning apparatus made in accordance with the present invention.

### DETAILED DESCRIPTION

At a high level, aspects of the present invention are directed to reducing carbonate, or temporary hardness in water using a combination of induced ionic flows and controlled ion filtration. In the examples described herein, ionic flows of the carbonate-hardness-related ions, i.e., the alkaline earth metal (AEM) cations (e.g., calcium (Ca²⁺) and magnesium (Mg²⁺) cations) and their corresponding carbonate-based anions (e.g., carbonate (CO₃²⁻) and bicarbonate (HCO₃⁻ anions), is induced using electrodes, and controlled ion filtration is performed using a filter designed and configured, or configured and selected, to selectively pass the AEM cations in the ionic flow of AEM cations and to selectively block the carbonate-based anions in the ionic flow of carbonate-based anions. In this manner, the amount of scale-producing AEM cations can be reduced in the water on one side of the filter to produce conditioned water, and, correspondingly, the concentration of such cations can be increased on the other side of the filter. As will be seen below, the cation-reduced conditioned water can be used for any suitable human-activity-based use, such as for making steam and/or making hot water, among many others, while the cation-concentrated water can optionally be processed to remove the cations. In addition, a portion of the conditioned water can be recirculated to the other side of the ion-selective filter, wherein its elevated acidity can be used to dissolve scale that may tend to build up there. Additionally, or alternatively, all or a portion of the conditioned water can be provided to another ionic flow/ion filtering device for further processing. These and other aspects of the present invention are described below in detail. As those skilled in the art will understand after reading this entire disclosure, water conditioning cells, devices, and systems made in accordance with the present invention can be made and operated relatively inexpensively, making them more desirable than conventional hardness removal systems.

Typically, calcium carbonate hardness is the most prevalent form of carbonate hardness. It is estimated that 70% of water hardness and buildup of scale is attributed to calcium carbonate (CaCO₃) and 30% to magnesium carbonate (MgCO₃). Therefore, calcium carbonate hardness is addressed in more detail herein than other forms of hardness, though this is not to mean that aspects and features of the present invention are applicable only to calcium carbonate.

For CaCO₃(s) to form in water, calcium Ca²⁺ and bicarbonate 2HCO₃⁻ ions are needed. If one of these is not available, then the process of formation may not occur. Since CaCO₃(s) disassociates in H₂O into a carbonate ion CO₃²⁻ and a calcium ion Ca²⁺, the anions and cations can be attracted to polarized electrodes. If a separation barrier, i.e., an ion-selective filter, designed and configured to prevent ion migration is placed between electrodes inside a cavity, then separated ions will flow out in two separate streams. Since negatively charged ions (anions) are always larger than the neutral atoms from which they are derived and positively charged ions (cations) are always smaller, a properly selected separating membrane can be used to inhibit the larger ions (anions) from crossing the barrier. Cations, such as Ca²⁺, Mg²⁺, H₃O⁺, will migrate toward a negatively charged cathode, leaving the positively charged anode with Off, HCO₃⁻ and Cl⁻ (if present) anions. This will increase the pH level on the cathode side and reduce the pH level on the anode side. Since both streams tend toward a state of equilibrium, a Ca²⁺-rich stream can be purified via precipitation and an anode stream can be utilized, if desired, to dissolve calcium deposits.

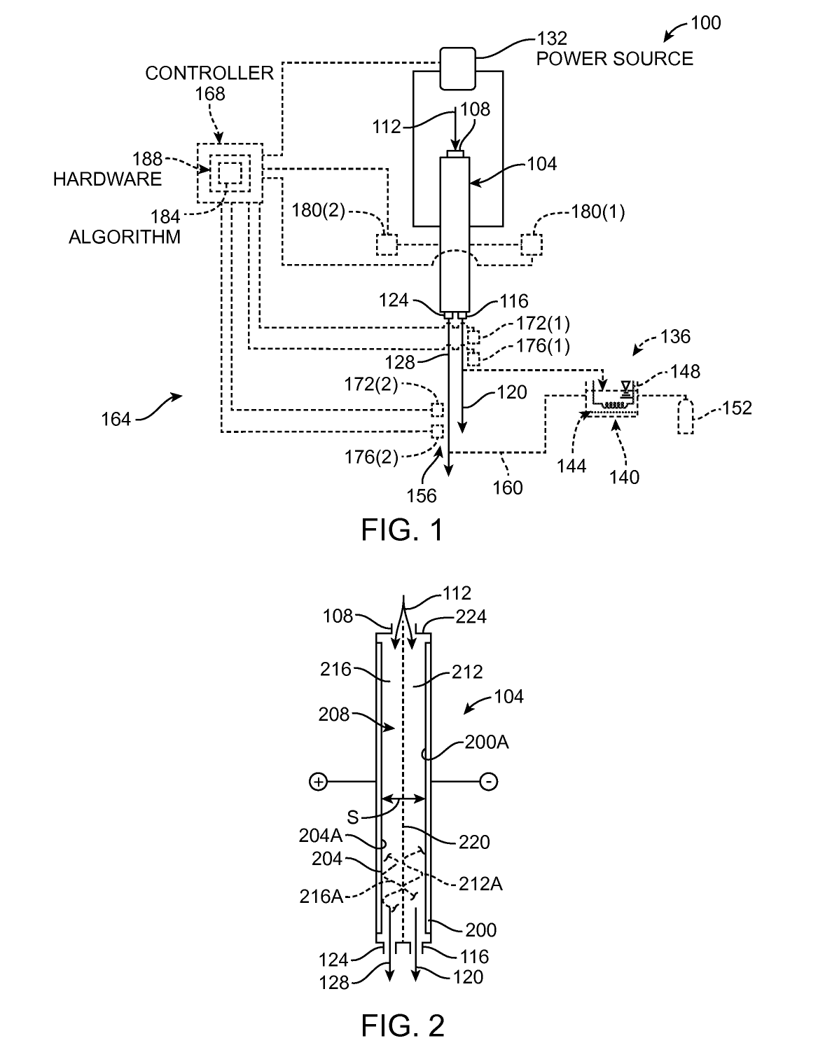

Referring now to the drawings, FIG. 1 illustrates an exemplary water-conditioning apparatus 100 made in accordance with the present invention. In this example, apparatus 100 includes a conditioning cell 104 having a water inlet 108 that, during use, receives water 112 to be conditioned. In this example, conditioning cell 104 also includes a pair of water outlets, a cathode-side outlet 116 that outputs a cathode water flow 120 and an anode-side outlet 124 that outputs an anode water flow 128. As will be understood after reading this entire disclosure, anode water flow 128 is considered herein to contain the “conditioned” water, with scale-producing AEM cations being removed, and cathode water flow 120 may be considered to contain “waste” water in some circumstances, though this waste water may be further processed and/or used for one or more end-use processes. It is noted that in this example, water inlet 108, cathode-side outlet 116, and anode-side outlet 124 are shown in the singular, but in other embodiments any one or more of these items may be replaced by two or more of the corresponding items, depending on the desired design.

FIG. 2 illustrates conditioning cell 104 in more detail. As seen in FIG. 2, conditioning cell 104 includes a cathode 200 and an anode 204 separated from one another to partially define an interior space 208 within the cell. Correspondingly, interior space 208 comprises a cathode side 212 and an anode side 216, with the cathode and anode sides being separated from one another by an ion-selective filter 220, such as a hydrophilic membrane filter. As readily seen in FIG. 2, water inlet 108 is in fluid communication with both cathode and anode sides 212, 216 so that water 112 flowing into interior space 208 is separated into cathode water flow 120 and anode water flow 128 on the corresponding respective sides of conditioning cell 104. As those skilled in the art will readily appreciate, because both cathode and anode sides 212, 216 are in fluid communication with water inlet 108 the pressures of water 112 on both of these sides are typically, though not necessarily, equal or substantially equal to one another.

Referring again to FIG. 1, and also to FIG. 2, water-conditioning apparatus 100 also includes an electrical power source 132 for energizing cathode 200 and anode 204 to, respectively, create the negative and positive electrical charges. Each of cathode 200 and anode 204 may be made of any suitable material, such as stainless steel or graphite, among many others. Power source 132 is preferably a direct-current (DC) power source, though in other embodiments an appropriately rectified alternating-current (AC) power source may be used. In some embodiments, power source 132 may be a variable DC power source to accommodate adjustability. Since, as noted above, an aspect of water condition in accordance with the present disclosure is to create ionic currents, it can be desirable to minimize the operating voltage of power source 132 by reducing the resistance within conditioning cell 104 by selecting a relatively small spacing, S, between the facing faces 200A, 204A of cathode 200 and anode 204, respectively.

In some embodiments, one, the other, or both of cathode and anode sides 212, 216 may optionally be provided with a corresponding spacer 212A, 216A that provides one or more functions. These functions include, but are not limited to: maintaining uniform flow on each of cathode and anode sides 212, 216 by preventing ion-selective filter 220, especially when it is a membrane, from blocking flow; reducing risk of damage to the membrane when pressure is uneven as between the cathode and anode sides; maintaining even tension on the membrane, maintaining constant volume on both the cathode and anode sides, and allowing very small spacing S between cathode and anode 200, 204, which as mentioned elsewhere herein, can provide significant advantages. It is noted that only a portion of each spacer 212A, 216A is shown in FIG. 2. Those skilled in the art will readily appreciate that the size and extent of each spacer 212A, 216A can be selected to suit the particular design conditions. In some embodiments, each spacer 212A, 216A may be formed from a material applied to ion-selective membrane 220 and/or one, the other, or both of cathode and electrode 200, 204, whereas in other embodiments, each spacer 212A, 216A may be provided as a separate structure.

Most of the operating parameters for conditioning cell 104 are related to properties of water 112 being treated, the particular application, and the particular design of the cell. Temperature of water 112 can, for example, be in the range from 0 to 100° C. at standard pressure, but in some applications the optimal range may be from about 5° C. to about 25° C. at standard pressure. Conductivity range of treated water with dissolved calcium and magnesium chemical compounds can be as low as zero and as high as saturation, but the optimal range may be from 100 μS/cm to a saturation point. Volumetric flow range may be as low as 0.1 liters per minute (LPM) or as high as 4 LPM for a single small version of conditioning cell 104. In some embodiments, DC voltage may be as low as 5V or as high as 140V. Most of the tests were performed within 0 VDC to 30 VDC, 120 VDC, and 140 VDC, since such power supplies were readily available. The current flow may, in some embodiments, be as low as 10 mA or as high as 20 A; the most common range tested was 0.5 A to 3 A. Of course, these operating parameters can be varied as needed according to the scale of the conditioning cell.

It is noted that when current is increased, the conductivity of cathode water flow 120 increases steadily; on the other hand, the conductivity of anode water flow 128 initially decreases and then begins to increase. This suggests that free ions present in the solution may be involved in reactions prior to electrolysis of water taking place. Loosely applying Faraday's 1st law of electrolysis, which states that “the mass of a substance altered at an electrode during electrolysis is directly proportional to the quantity of electricity transferred at that electrode,” it takes a well-defined quantity of energy to transfer a known amount of calcium ions to cathode water flow 120. As such, adding more than a particular quantity of energy will not result in further transfer of calcium ions to cathode water flow 120. The present inventor has also observed that a plot representing pH level of cathode water flow 120 as a function of temperature has a clearly visible plateau. This may be an indicator that cathode water flow 120 is approaching saturation level for given conditions; in such a case, further current increase will have limited or no effect on the pH level of the cathode water flow. Accordingly, a maximum pH level of cathode water flow 120 may be determined as a function of current applied to the cathode water flow.

Equally interesting are pH changes relative to current changes. After reaching a certain level of ionizing current, little or no further change in pH can be effected through further increases in the current. Such a level of ionizing current may be considered an optimum operating point. In some cases, the minimum conductivity of anolyte may be related to the leveling-off point of pH of catholyte.

To remove or to dissolve calcium carbonate, there must be a sufficient amount of this chemical compound to precipitate or to dissolve. Since a proposed performance envelope for some embodiments of water-conditioning apparatus of the present disclosure can be defined within 5≦pH≦11, 10° C.≦t≦90° C. limits @ 1,013 hPa pressure, minimum quantities of CaCO₃ needed for saturation and subsequent precipitation can be relatively well defined.

A water-conditioning apparatus of the present disclosure, such as water-conditioning apparatus 100 of FIG. 1, can be configured to concentrate, precipitate, and then remove hardness components, such as calcium carbonate, from water so as to act as a purifier. In the context of conditioning cell 104 of FIGS. 1 and 2, concentration is performed via the ion-filtering process described above. In the context of calcium carbonate, the following chemical reactions can be helpful in understanding the ion separation process:

CaCO₃=CO₃²⁻+Ca²⁺ [When added to water, CaCO₃ will ionize.]

H₂O->OH⁺+H₃O⁺ [Water is partially ionized (hydroxide and hydronium ions).]

2H₂O+CO₂=HCO₃⁻+H₃O⁺[CO₂ from air will form bicarbonate and hydronium ions.]

So there are CO₃²⁻, OH⁻, and HCO₃⁻ ions that will flow toward anode 204 and Ca²⁺ and H₃O⁺ ions that will flow toward (−) cathode 200 when in the presence of the electric field created by power supply 132 energizing the anode and cathode. As noted above, a hydrophilic ion-selective filter 220, such as a NAFION® membrane (NAFION® is a registered trademark of E.I. DuPont de Numours) allows certain ions to pass through but can create a high resistance for flowing water, thus permitting a flow of parallel cathode and anode water flows 120, 128 without mixing between the two flows. Cathode and anode water flows 120, 128 act as carriers of the ions. A suitable hydrophobic membrane may be inert and, as such, may not play a significant role in the chemical and/or electrochemical reactions. However, an active membrane, such as a NAFION® membrane, may improve the process of ion separation (this type of membrane is used in electrolyzers and fuel cells, as well as in chloralkali processes). A hydrophilic membrane may not allow gases such as O₂, H₂ and Cl₂ to pass.

Regarding precipitation, the following two reactions relating to the precipitation of calcium carbonate are often presented in scientific papers:

Ca²⁺+HCO₃⁻+OH⁻->CaCO₃+H₂O

Ca²⁺+CO₃²⁻->CaCO₃

CaCO₃ is soluble in acid, which is locally produced in high concentrations in the anolyte of a water electrolysis cell. (“Anolyte” is that portion of the electrolyte in the immediate vicinity of the anode—the corresponding portion in the immediate vicinity of the cathode is referred to as the “catholyte”). The acidity (H⁺) generated at anode 204 may react with and dissolve mineral carbonate placed immediately adjacent to the anode. The resulting Ca²⁺ and CO₃²⁻ ions may then migrate toward cathode 200 and anode 204, respectively, thus forming Ca(OH)₂ and H₂CO₃ (and/or CO₂+H₂O), respectively. It should be noted that at pH≧8.2, all CO₂ is converted into the bicarbonate ion HCO₃⁻.

Based on the following reaction:

Ca(OH)₂(aq)+CO₂(g)->CaCO₃↓(s)+H₂O(l)

if the catholyte, here, cathode water flow 120, is exposed to ambient CO₂ or gas from a bottle is percolated through it, then solid CaCO₃ will precipitate. At this point, cathode and anode water flows 120, 128 can be processed differently. Based on a specific application, anode water flow 128 containing very little calcium ions, relatively high acidity and in most cases lower conductivity than the original solution can be used for a particular use, such as in generating steam. In one example of steam generation, the steamer can be a ohmic-heating type steamer in which anode water flow 128 is provided to the steamer after being doped with NaCl. Cathode water flow 120, being basic, having high concentration of calcium ions, and high conductivity, can, for example, be used for a particular purpose, such as in an ohmic heating process because of its high conductivity, or further processed to remove hardness and then used for a particular purpose, among other things.

For the removal step, in strongly basic conditions, the carbonate ion (CO₃⁻) predominates, while in weakly basic conditions, the bicarbonate ion (HCO₃⁻) is prevalent. In more acid conditions, aqueous carbon dioxide, CO₂(aq), is the main form. Since most of HCO₃⁻ and CO₃²⁻ ions are in anode water flow 128 and the CO₂ may not be available because cathode water flow 120 may not be exposed to ambient CO₂, CO₂ injection may be a practical option. Such removal (purification) can utilize the physical and chemical properties of compounds involved, saturation with temperature and pH, as well as the effect of CO₂ on precipitation.

Referring particularly to FIG. 1, removal of the precipitate may be effected using one or more precipitators 136 for collecting the precipitate. In some embodiments, each precipitator 136 may include a precipitate removal system 140 for removing precipitate deposits 144 and further may optionally include one or both of a heater 148 and a CO₂ injection system 152 for enhancing the effectiveness of removal as described elsewhere in this disclosure. As illustrated by confluence 156, the output flow 160 of precipitator(s) 136 may be joined with output anode water flow 128, if desired.

A water purification apparatus of the present disclosure, such as water-conditioning apparatus 100 of FIG. 1, may operate under one or more of the following principles of operation:
input water 112 is unsaturated with CaCO₃;
input water 112 is split into cathode and anode water flows 120, 128 separated by an ion-selective filter;
the ratio of cathode and anode water flows 120, 128 is such that increased concentration of Ca²⁺ ions is on cathode side 212;
the ratio of cathode and anode water flows 120, 128 is automatically adjusted to maximize concentration of cations;
DC voltage is applied to cathode 200 and anode 204;
to achieve maximum saturation on cathode side 212, inlet water cools cathode 200;
output cathode water flow 120 is heated and doped with CO₂;
precipitated CaCO₃ is collected and periodically removed; and
purified water is returned to the system.

### Conditioning Cell Design Considerations

Below are outlined some elements of the design and factors that may have to be taken into consideration when designing a water conditioning cell of the present invention, such as conditioning cell 104 of FIGS. 1 and 2. For convenience of illustration, references are made to specific components and features of conditioning cell 104. However, it should be understood that the design considerations are not limited to the particular configurations and arrangement of components illustrated by conditioning cell 104.

### Ion-Selective Filter—Electrode Spacing

The spacing between ion-selective filter 220 and each of cathode 200 and anode 204 can significantly influence performance of conditioning cell 104. During the process of electrolysis, bubbles of H₂ will be created on cathode 200 and Cl₂ will likely be created on anode 204 if water 112 contains chlorides. Bubbles may grow bigger along the path of the flow, thereby increasing resistance. The concentration of ions may also change along the path and/or along the spacing S between each of cathode 200 and anode 204 and ion-selective filter 220, with a local maximum close to each of the cathode and anode. There is a saturation point where the effectiveness of the process rapidly deteriorates with increase of ion saturation. Combining these two conditions may lead to an unconventional design that incorporates a slanting of one, the other, or both of cathode 200 and anode 204, rather than parallel ones. This concept may be used to effect an acceptable balance of benefits and manufacturing complexity. Tested prototypes had parallel cathode 200 and anode 204 equally spaced and symmetrical with respect to filter 220.

### Spacing Between Electrodes

From an electrical standpoint, the electrical resistance across cathode 200 and anode 204 is a function of S/A, where, as noted above, S is the spacing between the cathode and anode and A is the facial area of the cathode and anode, assuming equal facial areas. In reality, the actual area may deviate from the area of the electrode if the path of ionic current is not uniform. It is noted that when cathode 200 and anode 204 have differing facial areas, the smaller facial area should be used to define resistance. The spacing S is the total distance between cathode 200 and anode 204. Since filter 220 creates two separate chambers within interior space 208, cathode water flow 120 and anode water flow 128 on each of the respective cathode side 212 and anode side 216 exhibiting differing electrical properties from one another. Certain designs may use different spacing for cathode 200 and anode 204 from filter 220 such that the differing conductivities are compensated for and the lowest possible resistance is implemented. This can be important in some embodiments in which the objective is to separate ions, not to produce heat. Outside of the ohmic heating field, any temperature increase may be considered a waste of energy. Keeping resistance low will reduce heat generation in accordance with W=I²·R·τ[J]. Lower resistance may allow for use of lower voltage for the same current I=U/R (I: current; U: voltage; R: resistance).

### Water Flow Velocity

Variable fluid velocity in a fixed geometry configuration translates into variable mass transfer. More flow may result not only in more ions, but also in more gas bubbles that have to be removed, but only if there is enough electric current to support the increased level of electrolysis needed in accordance with Faraday's law. For each conditioning cell 104, there is an optimum flow range that may be determined experimentally. Prototypes were tested with volumetric water flows ranging from 0.1 LPM to 4 LPM. The effect of different flows on ionic current at constant voltage is measurable and apparent almost immediately after changing the flow.

### Water Inlet—Outlet Locations (Parallel or Cross Flow)

Performed tests indicate that parallel flow of water is better than counter flow. However, this may not always be the case, particularly in implementations involving variable flow, different concentration of total dissolved solids and/or different currents. However, should cathode 200 and anode 204 not cover the whole length of ion-selective filter 220, the performance of conditioning cell 104 may deteriorate rapidly. It is speculated that ions may recombine rapidly in this case, reversing the electrolysis process. It was also observed that when the Y-branch configuration of water inlet 108 does not provide a sufficient separation of cathode side 212 and anode side 216, then leakage between cathode water flow 120 and anode water flow 128 within interior space 208 can be significant, reducing the performance of conditioning cell 104.

### Area of Cathode and Anode

To show that Ohm's Law applies to this design, prototypes with differing areas of cathode 200 and anode 204 were tested. In a single statement: if the area of an electrode doubles, when all other variables remain unchanged, the current doubles. Care should be taken when the cathode 200 and anode 204 do not have the same areas or when two sides of the cathode and/or anode are exposed to the respective cathode water flow 120 and anode water flow 128.

Taking a closer look at the ratio of S/A (spacing S between cathode 200 and anode 204 and cross section area, A, of the ionic current flow path, which as an approximation was treated as an area of the cathode and/or anode), one may correctly conclude that the lower this ratio, the lower the resistance will be. As an example, using 1/16″ spacing and 1.5″×9″ electrodes (1.524×10⁻³ m and 8.71×10⁻³ m², respectively) would yield an S/A ratio of 0.175. Actual tests confirm the general range of this ratio, though other factors may be involved. Using the theoretical ratio as a starting point may put the design in a ballpark, then the design can be adjusted later based on test data.

### Applied Voltage

There is a minimum voltage required for the process to take place. Since the voltage is low, in the range of 1.4 VDC to 2.4 VDC, and conventional practical voltages are 5 VDC, 12 VDC, 24 VDC, 48 VDC, 60 VDC, and 120 VDC, the minimum voltage may be irrelevant. Tests were performed with a variable DC voltage up to 30V and fixed DC voltages of 120V and 140V, though other voltages could be used. Safety is a factor when selecting the maximum operating voltage. For solar panel operation, 24-48-60 VDC can be optimal with proper load matching. Under most typical conditions, the voltage need not be higher than 60 VDC.

The actual minimum voltage required can be based on the geometry of conditioning cell 104 and the conductivity of water 112. It is difficult to calculate the true resistance of conditioning cell 104 because so many factors are involved, such as temperature differential between inlet and outlet, concentration of ions, type of ions, flow velocity, geometry, etc. In experiments, resistance was determined to be somewhere between the resistances calculated for inlet and outlet water parameters. In any case, several experimental values could be used as a starting point for the design. The range of values for test prototypes were from around 30Ω to 100 Ω.

### Ionic Current

Under Faraday's 1^{st} and 2^{nd} Laws of Electrolysis, the higher the electrical current, the better the results. However, electrical current itself will not be sufficient for the process to proceed. Ions are supplied by the flowing stream of water 112. Water with too much electrical current and not enough ions will produce a similar effect to situations wherein there is not enough electrical current and too many ions. To optimize the process, a proper balance may be determined experimentally. Since this is a dynamic process, a constant monitoring of water condition may be necessary. High current will have the tendency to electrolyze and heat water 112, both of which may have positive effects and be desirable under certain conditions, for example, increasing conductivity for power control and heating.

### Water Saturation Level

The saturation level of water 112 is a function of its pH and temperature. Feed water 112 may contain various levels of dissolved solids in the form of ions, which may result in differences in conductivity. Ionization of distilled water under conditions specific to conditioning cell 104 may result in increases of conductivity from approximately 4 μS/cm to 35 μS/cm. This may occur even if there is no increase in total dissolved solids. Since there are only three possible scenarios as far as water saturation is concerned (unsaturated, saturated, and with deposits of solids), decreasing pH may only be useful when there are solids available to be dissolved.

Experiments conducted with saturated water indicated that temperature increase due to Joule heating effect can cause precipitation that cannot be compensated for with a decrease in pH due to the presence of carbonic acid or, in the case of a pH higher than 8.2, due to bicarbonate ions. If not judiciously designed, the water conditioner may collect precipitated CaCO₃ in areas of low velocity flows.

### Fluid Ionization Level

Tests indicate that with increased concentration of ions, the efficiency of the separation process decreases to a point at which further increase of current can electrolyze the solvent rather than the solute, which cannot only waste energy but also generate hydrogen at cathode 200 and oxygen at the anode 204, gases that will typically have to be removed from a system incorporating conditioning cell 104.

### Types of Dissolved Solids

In many cases, chlorides and other highly soluble chemical compounds can be found in water. A primary, though not exclusive, objective of this conditioning cell 104 is to eliminate hard-to-dissolve calcium compounds, and particularly calcium carbonate (CaCO₃).

### Calcium Hydroxide and Exposure to Ambient CO₂

When CaCO₃ is split into calcium ions (Ca²⁺) and carbonate ions (CO₃²⁻) and these components are isolated from one another, the system will tend towards equilibrium. Water is typically already ionized with hydronium ions (H₃O⁺) and hydroxide ions (OH⁻). Grouping all of these ions based on their electric charge typically result in Ca²⁺ and H₃O⁺ being grouped on cathode side 212 and CO₃²⁻ and OH⁻ being grouped on anode side 216. As a result, there will typically be carbonic acid (H₂CO₃) on anode side 216 and calcium hydroxide (Ca(OH)₂) on cathode side 212.

High concentration of carbonic acid make a very good environment for dissolving more calcium carbonate, though, in this context, most of it was already ionized and moved to cathode side 212. With an innovative design of conditioning apparatus 100, anolyte from anode side 216 can be utilized to dissolve calcium deposits in amounts corresponding to the calcium deposits removed on cathode side 212.

On cathode side 212, newly created hydroxide, when exposed to carbon dioxide, will convert to calcium carbonate and water. Since Ca(OH)₂ is much more soluble in water than CaCO₃ and the created volume of hydroxide is only as high as the volume of available calcium and hydronium ions, much more Ca(OH)₂ can be dissolved than CaCO₃ before precipitation starts. This leads to two useful processes: one involving looping fluid several times to pump more calcium into the input stream, and the other requiring processing the fluid and splitting it into smaller and smaller streams with higher and higher concentrations of calcium compounds. Both methods were tested and both work; however, the effectiveness of both drops significantly with each cycle due to conditions described herein.

When calcium hydroxide is exposed to carbon dioxide, calcium carbonate and water are formed. Exposing cathode water flow 120 to ambient CO₂ may nearly instantaneously result in the water becoming milky. This process typically decreases pH and conductivity of flow, since the solid CaCO₃ will precipitate. This process can be accelerated by injecting CO₂.

### Anolyte and Catholyte Exposure to Ambient CO₂

As described above, Ca(OH)₂ exposed to CO₂ (from the atmosphere or otherwise) will convert to CaCO₃. This can result in a decrease of conductivity and pH and, particularly in cases involving highly saturated fluids, a precipitation of CaCO₃. When conductivity of water is enabled primarily by a certain presence, in parts-per-million, of CaCO₃, then, regardless of how high the conductivity of fresh cathode water flow 120 is, after a long enough period of being exposed to CO₂, the conductivity of the cathode water flow will level off at a level that may or may not correspond to a saturation level, depending on the level of calcium compounds in the water. A decrease in pH in cathode water flow 120, which may correspond to a leveling-off or decrease in conductivity, may also occur. Conductivity levels of anode water flow 128 do not change significantly over long periods of time. The initial drop may be attributed to depletion of calcium ions, while the increase may result from formation of a carbonic acid.

### Temperature of the Water

Since increases in temperature tend to decrease the solubility of calcium carbonate, heat generated should be minimized at least in the electrolytic cell. On the other hand, if a precipitator is used, elevated temperature will speed up the process of removing solids.

### Working Pressure

Other publications extensively cover the effect of pressure on solubility of calcium compounds. However, pressure has had little measurable effect on the quality of the process of water purification described herein. From a mechanical standpoint, the design of the electrolytic cell may be greatly influenced by the working pressure. Based on the intended application, the outer housing 224, any gaskets (not shown), and mounting of ion-selective filter 220 must be carefully designed to avoid leaks and mechanical failures.

### Cross Contamination and Stray Current Prevention

One of the experiments involved cathode 200 and anode 204 that did not cover the whole exposed area of ion-selective filter 220. There was a very significant reduction of performance of conditioning cell 104, likely due to diffusion of ions through ion-selective filter 220 in absence of the electric field. Both cathode 200 and anode 204 had the same width and length and were facing one another. Similar negative effects may take place when one of cathode 200 and anode 204 is shorter. A second issue encountered is that when the “Y” inlet was too close to the interior space 208, unbalanced pressure forced fluids to spill over from one of cathode side 212 and anode side 216 to the other, thereby contaminating already separated streams and significantly reducing performance.

As those skilled in the art will appreciate, the bias current should be judiciously determined in order to optimize ion separation without wasting energy on water electrolysis. Tests performed on distilled water indicate that a conductivity increase of 30 μS/cm can be expected due to electrolysis.

Referring again to FIG. 1, water-conditioning apparatus 100 may optionally include a control system 164 for controlling one or more operating parameters of the apparatus, such as applied voltage (induced current) and spacing of electrodes 200, 204 (FIG. 2), to ensure desired operation of the apparatus. In the embodiment shown, control system 164 includes a controller 168, a pair of conductivity sensors 172(1), 172(2) for measuring the conductivity of cathode and anode flows 120, 128, respectively, a pair of pH sensors 176(1), 176(2), for measuring the pH of the cathode and anode flows, respectively, and a pair of electrode actuators 180(1), 180(2) for moving, respectively, cathode 200 (FIG. 2) and anode 204 in response to control signals (not shown) from the controller in order to adjust spacing S (FIG. 2) between these electrodes. In this example, controller 168 receives measurement signals (not shown) from conductivity sensors 172(1), 172(2) and pH sensors 176(1), 176(2) and executes a suitable control algorithm 184 that determines either the magnitude of voltage that power source 132 applies across cathode 200 (FIG. 2) and anode 204 or the spacing S (FIG. 2) between the electrodes, or both a voltage magnitude and spacing.

As those skilled in the art will readily appreciate, controller 168 can be composed of any suitable hardware 188, such as a microprocessor, application specific integrated circuit, system on chip, analog-to-digital converter(s), digital-to-analog converter(s), and any other support hardware, such as memory, power supplies, etc., needed for a particular instantiation. Similarly, each of sensors 172(1), 172(2), 176(1), 176(2) may be any suitable sensor that provides a measurement signal usable by controller 168 in either a raw or conditioned format. Each electrode actuator 180(1), 180(2) may be any suitable type of actuator, such as hydraulic, pneumatic, screw, magnetic, etc., that can be controlled by controller 168. In the embodiment shown, a pair of electrode actuators 180(1), 180(2) are shown so that cathode 200 (FIG. 2) and anode 204 can be moved in unison and in opposite directions to maintain equal volume on both sides of ion-selective filter 220 (FIG. 2). However, it is noted that electrode actuators 180(1), 180(2) can be replaced in other embodiments by a single actuator and, for example, a linkage or geared system, that can move both cathode 200 (FIG. 2) and anode 204 together using the single actuator. In yet other embodiments, only one or the other of cathode 200 (FIG. 2) and anode 204 may be actuatable. It is noted that those skilled in the art will readily be able to devise a suitable algorithm 184 for the particular instantiation of water-conditioning apparatus 100 at issue. Communications between/among the various components of control system 164 and power source 132 may be via wired and/or wireless communications channels as desired. For the sake of illustration, FIG. 1 illustrates the channels as being wired channels.

### Exemplary Water-Conditioning Systems

Three-Cell System with Parallel Treatment of Cathode and Anode Output Flows

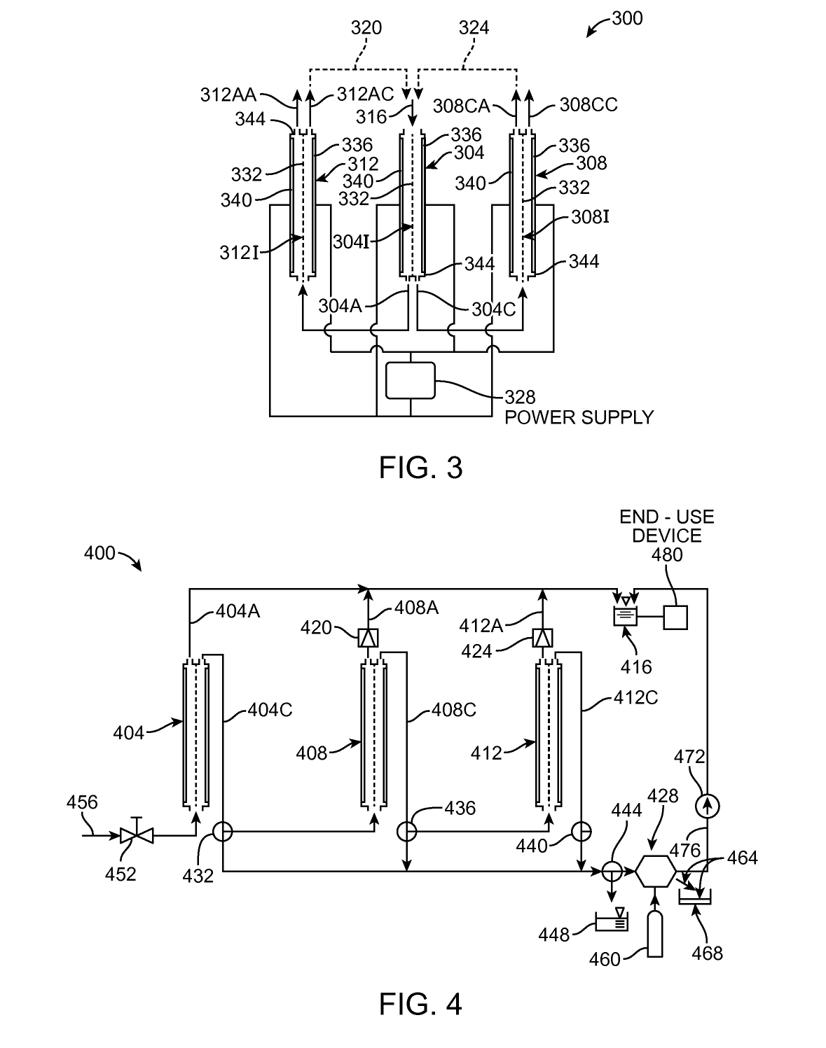

FIG. 3 illustrates an exemplary three-cell water-conditioning system 300 having three conditioning cells 304, 308, 312, each of which may be the same as or similar to conditioning cell 104 of FIGS. 1 and 2. Conditioning cell 304 receives an input water flow 316 and outputs a cathode flow 304C and an anode flow 304A in accordance with the principles of operation of conditioning cell 104 of FIGS. 1 and 2 described above. Cathode flow 304C is then provided to conditioning cell 308, wherein it is processed in accordance with the principles of operation of conditioning cell 104 of FIGS. 1 and 2 to produce a cathode-cathode flow 308CC and a cathode-anode flow 308CA. Similarly, anode flow 304A is then provided to conditioning cell 312, wherein it is processed in accordance with the principles of operation of conditioning cell 104 of FIGS. 1 and 2 to produce an anode-cathode flow 312AC and an anode-anode flow 312AA. Since anode-anode flow 312AA will be most acidic and cathode-cathode flow 308CC will be most basic, anode-cathode flow 312AC and cathode-anode flow 308CA can be reprocessed to avoid fluid loss, as indicated by optional recirculation loops 320 and 324. In a simplistic design (not shown), three-cell system 304 can be implemented using a single enclosure that defines three interior spaces that correspond, respectively to conditioning cells 304, 308, 312, a single cathode that spans all three cells, a single anode that spans all three cells, and a single hydrophilic ion-selective membrane that also spans all three cells. In such an embodiment, the cathode and anode may be energized by a single DC power source, which may be the same as or similar to DC power source 328 shown. Of course, many alternative designs can be created using multiple cathodes, multiple anodes, multiple membranes, multiple DC power sources, and/or multiple enclosures. FIG. 3 depicts a multiple-enclosure embodiment.

In exemplary prototypes, three-cell conditioning system 300 may have the following constructions. The hydrophilic ion-selective membrane 332 may be product type 5550-0208E-A1, hydrophilic, 5550PP laminated and coated, thickness 110 μm, porosity 55%, PP pore size 0.064 μm. In the embodiment described, this functional polymer membrane provides an electronic barrier between the positive and negative electrodes of each interior space 3041, 3081, 3121, while allowing the exchange of calcium ions from the anode side to the cathode side of each space. Each cathode 336 and anode 340 may each be 304 stainless steel having an 18 gage thickness. In alternative embodiments, cathode(s) 336 and anode(s) 340 may each be 316 stainless steel having a 16 gage thickness. In production systems, cathode(s) 336 and anode(s) 340 may be graphite or other suitable material. Each enclosure 344 may be made of one or more food grade materials resistive to action of acids and bases, such as ABS (acrylonitrile butadiene styrene) and/or PP (polypropylene) materials. V0 rating for ABS may be desirable in some applications.

In some embodiments, DC power source 328 may be a DC variable power supply. Since a primary objective is to form an ionic current, the operating voltage should be minimized by reducing the resistance of cells via reduction of distance between electrodes and increasing the area of cathode(s) 336 and anode(s) 340 exposed to each of cells 304, 308, 312. In one particular example, a nominal design point for DC power supply 328 may be 60 VDC, 360W, water conductivity of 100 μS/cm, and an S/A ratio of 0.1 m/m². In some embodiments, a suitable spacing S has been found to be from about 0.125 inch (mm) to about 0.1875 inch.

### Prototype and Test Results

A simple symmetrical three-cell model version of conditioning system 300 was designed and built, and the following tests were performed.
Test #1: measured water parameters of cathode-cathode (CC) flow 304C, anode-cathode (AC) flow 312AC, cathode-anode (CA) flow 308CA, and anode-anode (AA) flow 312AA taken immediately without system 300 energized;
Test #2: measurements of the CC, AC, CA, and AA flows taken immediately after energizing the system;
Test #3: measurements of the CC, AC, CA, and AA flows taken at 3 minutes of operation with the system energized;
Test #4: measurements of the CC, AC, CA, and AA flows taken at 3 hours of operation with the system energized;
Test #5: measurements of the CC, AC, CA, and AA flows taken at 24 hours of operation with the system energized;
Test #6: measurements of the CC, AC, CA, and AA flows taken prior to CO₂ doping;
Test #7: measurements of the CC, AC, CA, and AA flows taken after CO₂ doping;
Test #8: measurements of the CC, AC, CA, and AA flows taken 3 days after CO₂ doping;
Test #9: measurements of the CC, AC, CA, and AA flows taken prior to CaCO₃ doping; and
Test #10: measurements of the CC, AC, CA, and AA flows taken after CaCO₃ doping.
   Conductivity and pH measurements from these tests are illustrated, respectively, in the following Tables I and II.

TABLE I
Conductivity (μS/cm)

| Test | 1 | 2 | 3 | 4 | 5 | 6 | 7 | 8 | 9 | 10 |
|---|---|---|---|---|---|---|---|---|---|---|
| CC | 121.9 | 500 | 429 | 413 | 301 | 299 | 186 | 176 | 184.7 | 215 |
| AC | 121.9 | 57.9 | 60 | 59 | 61.9 | 72.5 | 83.8 | 75.3 | 76.6 | 102.4 |
| CA | 121.9 | 145.3 | 125.1 | 172.5 | 132 | 97.6 | 111.9 | 128.3 | 130.7 | 149 |
| AA | 121.9 | 301 | 274 | 336 | 349 | 356 | 366 | 320 | 257 | 238 |

TABLE II
pH

| Test | 1 | 2 | 3 | 4 | 5 | 6 | 7 | 8 | 9 | 10 |
|---|---|---|---|---|---|---|---|---|---|---|
| CC | 9.2 | 10.96 | 10.87 | 10.92 | 10.69 | 10.71 | 5.63 | 8.75 | 8.29 | 8.49 |
| AC | 9.2 | 6.78 | 6.18 | 6.73 | 6.39 | 6.62 | 5.14 | 8.51 | 8.09 | 8.79 |
| CA | 9.2 | 10.22 | 10.23 | 10.2 | 10.15 | 9.03 | 5.38 | 8.63 | 8.35 | 8.46 |
| AA | 9.2 | 4.53 | 4.53 | 4.3 | 4.12 | 4.36 | 4.2 | 4.25 | 5.59 | 7.57 |

To perform the tests noted above, a regulated DC power supply was used. Clean power generated by such a power supply typically has little to no ripple and can provide a steady voltage similar to that of a battery but at a significant cost. In absence of an electric field, ions have a tendency to diffuse and recombine, which can make the process of ion separation less efficient. By using a simple bridge rectifier and a capacitor, the size and cost of a water conditioner made in accordance with the present invention may be significantly reduced. Additionally, such an approach allows for the use of a “chopper” or a phase angle controller to vary the bias current. A simple power supply may be connected to an autotransformer. Although such a power supply may be designed to handle 30 A current, currents under 15 A may be used. Such a power supply may be used instead of a regulated power supply. As such, a simple, inexpensive power supply and the above-mentioned control methods may be used to enable the water conditioner to perform as intended and described herein.

Three-Cell System with Cascading Treatment of Cathode Output Flows

FIG. 4 illustrates another exemplary three-cell water-conditioning system 400 having three conditioning cells 404, 408, 412, each of which may be the same as or similar to conditioning cell 104 of FIGS. 1 and 2. In this embodiment, conditioning cells 404, 408, 412 are generally arranged in a serial fashion, with the anode flow 404A, 408A, 412A of each cell being directed to a collector reservoir 416 and the cathode flow 404C and 408C of each of cells 404, 408 capable of being directed to a next one of conditioning cells, here, cells 408, 412, respectively. In this example, water-conditioning system 400 includes a first check valve 420 for preventing anode flow 404A from flowing into conditioning cell 408 and a second check valve 424 for preventing anode flows 404A, 408A from flowing into conditioning cell 412. In this example, water-conditioning system 400 also has a precipitator 428, a first three-way valve 432 for controlling the amounts of cathode flow 404C sent to conditioning cell 408 and bypassed toward the precipitator, a second three-way valve 436 for controlling the amount of cathode flow 408C sent to conditioning cell 412 and bypassed toward the precipitator, a third, optional, three-way valve 440 in the event one or more additional stages (not shown) are implemented, and a fourth three-way valve 444 for controlling the amount of the cathode flow(s) sent to the precipitator or to a cathode-flow reservoir 448. An inlet valve 452 is provided to control an inlet flow 456 provided to water-conditioning system 400. In this example, precipitation within precipitator 428 is aided by CO₂ from a CO₂ gas supply 460 and sludge 464 from the precipitator is collected in a suitable sludge collector 468. A pump 472 is provided in this example to pump the cleaned water 476 from precipitator 428. Elements of water-conditioning system 400 not illustrated in FIG. 4 include a power source and corresponding electrical connections to the electrodes, which are not individually labeled in FIG. 4. Each of these elements may be the same as or similar to the corresponding respective elements of water-conditioning system 300 of FIG. 3.

As an example, water-conditioning system 400 of FIG. 4 may be used to slow the buildup of calcium deposits inside an end-use device 480, such as the heating vessel of a steam generator, boiler, etc. Devices such as steamers and boilers are challenging, since all impurities remain inside the heating vessels when water is evaporated. How much maintenance is required depends on the quality of feed water and the design of the steam generator.

Water typically carries various hardness creating compounds. To simplify the analysis, only calcium compounds, such as CaCO₃ and Ca(OH)₂, and sodium chloride (NaCl), will be considered. However, as those skilled in the art will appreciate, other compounds, such as magnesium compounds (e.g., MgCO₃ and Mg(OH)₂) can also or alternatively be considered. Typically, CaCO₃ and MgCO₃ are the worst and Ca(OH)₂ and Mg(OH)₂ have low solubility in water, but not as low as the former two. NaCl has high solubility in water comparing to other ionic compounds. In any event, over time solids will accumulate inside the heating vessel of end-user device 480. In testing involving an ohmic-heating-based steamer available from Ideas Well Done LLC, Winooski, Vt., the free volume between four electrodes and a graphite outer jacket of the steamer chamber was 80 cm³. With CaCO₃ density of 2.7 g/cm³, the mass of deposited solids will never exceed 216 g. Of course, this is an unrealistic scenario because the steamer will stop working long before such mass accumulates. On average, 20-30% of water is rejected and carries away a significant portion of solids. So, theoretically, how long would it take to fill up the cavity? The following two scenarios are contemplated: soft water having 50 mg/L dissolved calcium solids and hard water having 400 mg/L dissolved calcium solids.

Based on 6 liters of water per load and 1.5 hours of steamer run on one load, it can take as many as 1,080 hours for soft water and as few as 135 hours for hard water to deposit enough solids to fill up the generator. In reality, more time may be needed to fill up the cavity but less time may elapse before the unit stops working. The main problem is not the dissolved solids but the precipitated solids, which form hard scale. Particles of graphite, NaCl, and other chemical compounds are carried away with rejected water and thus do not form insulating layers.

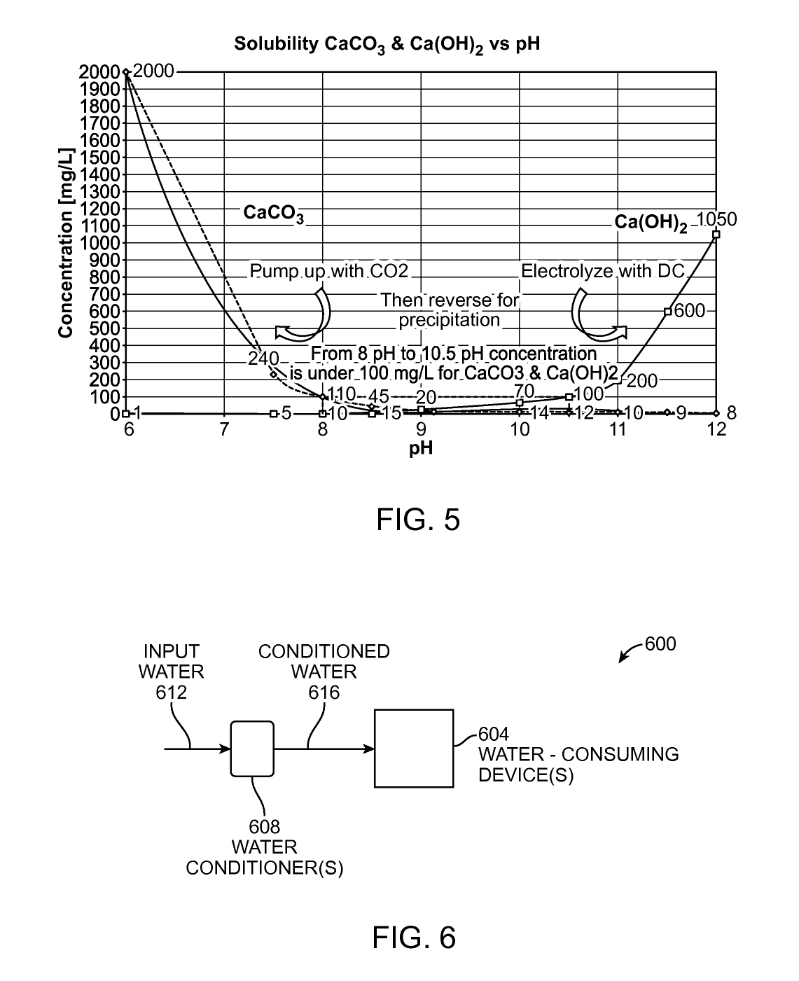

From FIG. 4, it is readily seen that varying pH affects the solubility of CaCO₃ and Ca(OH)₂. Changing pH may be accomplished using electric current, doping with CO₂, or by adding base or acid. One experiment that produced the same results (i.e., forcing calcium carbonate precipitation) as adding CO₂ to a solution of Ca(OH)₂ is adding a solution of Ca(OH)₂ to a solution of CaCO₃. Results achieved by this method are spectacular. Equal volumes of CaCO₃ having 828 μS/cm and 7.21 pH and Ca(OH)₂ having 5,310 μS/cm and 12.33 pH were mixed together. Immediately, the mixture turned white, and after the precipitation was completed, conductivity was reduced to 1,279 μS/cm and 11.77 pH. A thin layer of CaCO₃ was deposited on the bottom of the plastic cap within a minute or two. The chemical reaction can be easily understood through FIG. 5. The lowest levels of dissolved calcium compounds at saturated conditions in water can be achieved by maintaining pH around 9. Of course, if not enough solute is available, the solution will be unsaturated.

To extract solids from ionic solutions, two methods can be used: 1) evaporating solvents and 2) precipitating solutes. The first approach is very effective but does not remove the solute from the solution; it removes the solvent. The process of generating steam does exactly that. The second approach will require the solution to have a concentration of the solute above the saturation point, which may create problems when fluids have low concentration of total dissolved solids. Even when the extra solids precipitate, the rest of the fluid may be at saturation.

A purification method of the present disclosure may be based on the following principles and assumptions. The concentration of solution expressed in terms of percent by weight is % Solute=(g solute/g solution)×100%. If a half of the solution is removed, then the concentration will double. The chemical (electrochemical) reaction of an electrolysis of CaCO₃ results in creation of Ca(OH)₂. Since solubility of Ca(OH)₂ is much higher than solubility of CaCO₃, more calcium can be “packed” into the same volume of solvent. When pH of the solution is reduced, the saturation of Ca(OH)₂ is reduced, forcing precipitation. When CO₂ is added to Ca(OH)₂, the following reaction will take place: Ca(OH)₂(aq)+CO2(g)→CaCO₃(s)+H₂O(l). Solubility of CaCO₃ and Ca(OH)₂ are the lowest around 9 pH. The concentrated stream can be disposed of or further processed to remove calcium deposit and return water back to the system.

When water enters a first conditioning cell, such as conditioning cell 404 of FIG. 4, current and voltage measurements may be performed. Since the cell geometry may be fixed, calculated conductivity can be a function of the total dissolved solids. The water temperature is a factor as well, but anticipated ranges of temperatures should not significantly alter calculated resistance. It may be necessary to control pH levels as well in some implementations.

The calculated conductivity may be compared to a value in a cell calibration table (not shown), and a probability of an occurrence may be established. If the probability of an occurrence is significantly higher than the predicted saturation point for given conditions, the input water flow, such as inlet flow 456 of FIG. 4, most likely contains other soluble chemical compounds. As an example, for 20° C. and 7.5 pH, the expected value of conductivity for CaCO₃ is 500 μS/cm, though it may be lower.

Based on an obtained value of conductivity, an initial DC current can be established. In conditioning cell 404, inlet flow 456 is separated into two streams. Anode flow 404A can be directed toward a common collector, such as collector reservoir 416 of FIG. 4, to which streams from subsequent stages, such as conditioning cells 408, 412 and precipitator 428, can also be directed. Cathode flow 404C can be directed to a second stage conditioning cell, such as conditioning cell 408.

The efficiency of such a calcium separation process can be measured by comparing inlet and outlet conductivities. In a simplified explanation in which the anode and cathode flows are equal to one another, since the flow of the cathode flow is 50% of the initial flow, if all calcium ions are extracted, then conductivity should double. However, this is not the case in every situation because of differences in volumetric flows through both chambers, heating effects, etc.

The bias current has to be judiciously determined in order to get best ion separation without wasting energy on water electrolysis. Tests performed on distilled water indicate that a conductivity increase of 30 μS/cm can be expected due to electrolysis.

It should be noted that the catholyte will convert to Ca(OH)₂ (not CaCO₃) after passing through a conditioning cell. This means that there may be no precipitation inside the cells even if the conductivity increases dramatically. This is beneficial because even a small stream of water may contain a high concentration of calcium ions.

At this point, a decision can be made as to whether the stream containing a high concentration of calcium ions will be directed to the rejected water pan or further processed. The processing of the stream may include injection of CO₂ to reduce pH and to force CaCO₃ precipitation.

A precipitator, such as precipitator 428 of FIG. 4, can be a separate add-on unit that can process the catholyte from one or more stages; as such, a single precipitator can be used for an entire water-conditioning system. The precipitator, like precipitator 428, may be a flow-through unit capable of automatic adjustment of injected CO₂ to maintain an optimum pH level for CaCO₃ precipitation. Aggressive CO₂ doping may decrease pH to a level where solubility increases and the precipitation process will be less effective.

For a multi-cell water-conditioning system having a conditioning cell arrangement like the arrangement shown in FIG. 4, mass of catholyte as a function of mass of inlet water and number of cells is

m_{cN}=mᵢ·2^{-N}

wherein:
m_{cN}=mass of catholyte exiting N^{th} cell [kg];
mass of solution (water and solids) entering the first cell [kg]; and
N=number of cells.
   As an example, when N=6 and mᵢ=1 kg/min, m_{c6}=1·2⁻⁶=0.015625 kg/min, which is 1.56% of the initial flow.

The concentration of catholyte as a function of mass of inlet water, mass of solids, and number of cells is

ξ_{cN}=1/(1+(m_{wi}/mₓ)·2^{-N})

wherein:
ξ_{cN}=concentration of solids in catholyte water [kg/kg];
m_{wi}=mass of water (without solids) entering the first cell [kg]; and
mₓ=mass of solids (assuming mₓ at inlet equals mₓ in catholyte) [kg].
   As an example, when N=6, m_{wi}, =1 kg, and mₓ=50×10⁻⁶ kg (which is 50 ppm), ξ_{c6}=1/(1+(1/50·10⁻⁶)·2⁻⁶)=3.19·10⁻³ kg, which is 3 g/kg or 3,000 mg/kg or 3,000 ppm (of Ca(OH)₂).

FIG. 6 illustrates a system 600 that includes one or more water-consuming devices 604 and one or more water conditioners 608 designed and configured to condition input water 612 to provide conditioned water 616 to the one or more water-consuming devices. As those skilled in the art will readily understand, each water-consuming device 604 may be any of a wide-variety of elements, such as a water heater (e.g., for a steamer, boiler, domestic water heater, etc.), storage reservoir, humidifier, and hydrogen generator, among others. In some embodiments, system 600 may be contained in a single device, such as a coffee maker, garment steamer, carpet steamer, and clothes iron, among others. Fundamentally, there is no limitation on the nature and character of each water-consuming device 604, other than benefits derived from using conditioned water 616 therein relative to using input water 612 directly. Exemplary benefits of using conditioned water 616 over input water 612 are described or alluded to elsewhere herein and include reduced mineral scaling, reduced clogging, increasing energy efficiency, an reducing other detriments caused by undesirably high levels of hardness.

Each of the one or more water conditioners 608 may include one or more conditioning cells of the present disclosure, such as conditioning cell 104 of FIGS. 1 and 2, that may be plumbed in any suitable manner, such as parallel-plumbed as in exemplary three-cell water-conditioning system 300 of FIG. 3 or serially-plumbed as in exemplary three-cell water-conditioning system 400 of FIG. 4, or any suitable combination of parallel and serial plumbing or other plumbing arrangement. Fundamentally, there is no limitation on the configuration of each water conditioner 608 other than it be configured and operated to achieve the desired level of water conditioning. Using the present disclosure as a guide, those skilled in the art should readily be able to design and embody one or more water conditioners 608 suitable for the level of water conditioning desired without undue experimentation.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of conditioning water containing alkaline earth metal cations and corresponding carbonate anions, the method comprising:
flowing the water into a first conditioning cell having a first cathode side and a first anode side so as to provide, respectively, a cathode flow and an anode flow;
inducing the alkaline earth metal cations in the anode flow toward the first cathode side;
permitting the alkaline earth metal cations in the anode flow to pass to the cathode flow; and
inhibiting the carbonate anions in the cathode flow from passing to the anode flow.

2. A method according to claim 1, further comprising causing at least some of the alkaline earth metal cations in the cathode flow to precipitate.

3. A method according to claim 2, wherein said causing at least some of the alkaline earth metal cations to precipitate includes injecting carbon dioxide into the cathode flow.

4. A method according to claim 2, wherein said causing at least some of the alkaline earth metal cations to precipitate includes heating the cathode flow.

5. A method according to claim 1, further comprising looping a portion of the anode flow to the cathode flow.

6. A method according to claim 1, further comprising:
flowing the anode flow into a second conditioning cell having a second cathode side and a second anode side so as to have, respectively, an anode-cathode flow and an anode-anode flow;
inducing the alkaline earth metal cations in the anode-anode flow toward the second cathode side;
permitting the alkaline earth metal cations in the anode-anode flow to pass to the anode-cathode flow; and
inhibiting the carbonate anions in the anode-cathode flow from passing to the anode-anode flow.

7. A method according to claim 6, further comprising:
flowing the cathode flow into a third conditioning cell having a third cathode side and a third anode side so as to have, respectively, a cathode-cathode flow and a cathode-anode flow;
inducing the alkaline earth metal cations in the cathode-anode flow toward the third cathode side;
permitting the alkaline earth metal cations in the cathode-anode flow to pass to the cathode-cathode flow; and
inhibiting the carbonate anions in the cathode-cathode flow from passing to the cathode-anode flow.

8. A method according to claim 1, further comprising:
flowing the cathode flow into a second conditioning cell having a second cathode side and a second anode side so as to have, respectively, a cathode-cathode flow and a cathode-anode flow;
inducing the alkaline earth metal cations in the cathode-anode flow toward the second cathode side;
permitting the alkaline earth metal cations in the cathode-anode flow to pass to the cathode-cathode flow; and
inhibiting the carbonate anions in the cathode-cathode flow from passing to the cathode-anode flow.

9. A method according to claim 8, further comprising, flowing each of the anode flow and the cathode-anode flow to a reservoir.

10. A method according to claim 8, further comprising, causing at least some of the alkaline earth metal cations in each of the cathode flow and the cathode-cathode flow to precipitate.

11. A method according to claim 8, further comprising:
flowing the cathode-cathode flow into a third conditioning cell having a third cathode side and a third anode side so as to have, respectively, a cathode-cathode-cathode flow and a cathode-cathode-anode flow;
inducing the alkaline earth metal cations in the cathode-cathode-anode flow toward the third cathode side;
permitting the alkaline earth metal cations in the cathode-cathode-anode flow to pass to the cathode-cathode flow; and
inhibiting the carbonate anions in the cathode-cathode-cathode flow from passing to the cathode-anode flow.

12. A method according to claim 11, further comprising, flowing each of the anode flow, the cathode-anode flow, and the cathode-cathode-anode flow to a reservoir.

13. A method according to claim 11, further comprising, causing at least some of the alkaline earth metal cations in each of the cathode flow, the cathode-cathode flow, and the cathode-cathode-cathode flow to precipitate.

14. A method according to claim 1, wherein the alkaline earth metal cations are calcium cations.

15. A method according to claim 1, wherein the alkaline earth metal cations are magnesium cations.

16. A method according to claim 1, further comprising controlling a voltage applied to an anode on the anode side and a cathode on the cathode side as a function of at least one of a conductivity and a pH of at least one of the anode flow and the cathode flow.

17. A method according to claim 1, further comprising controlling a spacing between an anode on the anode side and a cathode on the cathode side as a function of at least one of a conductivity and a pH of at least one of the anode flow and the cathode flow.

18. An apparatus for conditioning water containing alkaline earth metal cations and carbonate anions, the apparatus comprising:
a first conditioning cell that includes:
a first cathode side;
a first anode side;
a first cathode located on said first cathode side;
a first anode located on said first anode side;
a first inlet designed and configured to receive the water and to provide the water to both said first cathode side and said first anode side to provide, respectively, a cathode flow and an anode flow;
a first cathode outlet designed and configured to allow the cathode flow to exit said first cathode side;
a first anode outlet designed and configured to allow the anode flow to exit said first anode side; and
a first ion-selective filter membrane separating the cathode flow and anode flow from one another, said first ion-selective filter membrane designed/configured/selected to, when the water is present:
permit the alkaline earth metal cations in the anode flow to pass to the cathode flow; and
inhibit the carbonate anions in the cathode flow from passing to the anode flow.

19. An apparatus according to claim 18, wherein said first cathode comprises a cathode plate having an expansive face, said first anode comprises an anode plate having an expansive face, said expansive face of said anode plate faces said expansive face of said cathode plate, and said cathode and said anode plates are spaced from one another by a distance of about 0.125 inch (3.175 mm) to about 0.1875 inch (4.7625 mm).

20. An apparatus according to claim 18, further comprising a recirculation loop designed and configured to recirculate at least a portion of the anode flow to said first cathode side of said first conditioning cell.

21. An apparatus according to claim 18, further comprising:
a second conditioning cell that includes:
a second cathode side;
a second anode side;
a second cathode located on said second cathode side;
a second anode located on said second anode side;
a second inlet in fluid communication with said first anode outlet so as to receive the anode flow and designed and configured to provide the anode flow to both said second cathode side and said second anode side to provide, respectively, an anode-cathode flow and an anode-anode flow;
a second cathode outlet designed and configured to allow the anode-cathode flow to exit said second cathode side;
a second anode outlet designed and configured to allow the anode-anode flow to exit said second anode side; and
a second ion-selective filter membrane separating the anode-cathode flow and anode-anode flow from one another, said second ion-selective filter membrane designed/configured/selected to, when the water is present and said second cathode and said second anode are energized:
permit the alkaline earth metal cations in the anode-anode flow to pass to the anode-cathode flow; and
inhibit the carbonate anions in the anode-cathode flow from passing to the anode-anode flow.

22. An apparatus according to claim 21, further comprising:
a third conditioning cell that includes:
a third cathode side;
a third anode side;
a third cathode located on said third cathode side;
a third anode located on said third anode side;
a third inlet in fluid communication with said first cathode outlet so as to receive the cathode flow and designed and configured to provide the cathode flow to both said third cathode side and said third anode side to provide, respectively, a cathode-cathode flow and a cathode-anode flow;
a third cathode outlet designed and configured to allow the cathode-cathode flow to exit said third cathode side;
a third anode outlet designed and configured to allow the cathode-anode flow to exit said third anode side; and
a third ion-selective filter membrane separating the cathode-cathode flow and cathode-anode flow from one another, said second ion-selective filter membrane designed/configured/selected to, when the water is present and said third cathode and said third anode are energized:
permit the alkaline earth metal cations in the cathode-anode flow to pass to the cathode-cathode flow; and
inhibit the carbonate anions in the cathode-cathode flow from passing to the cathode-anode flow.

23. An apparatus according to claim 18, further comprising a precipitator fluidly downstream from said first cathode outlet and designed and configured to precipitate at least some of the alkaline earth metal cations in the cathode flow.

24. An apparatus according to claim 23, wherein said precipitator further comprises a precipitation vessel and a carbon dioxide supply in fluid communication with said precipitation vessel.

25. An apparatus according to claim 23, wherein said precipitator further comprises a precipitation vessel for receiving at least a portion of the cathode flow, and a heater provided for heating the portion of the cathode flow.

26. An apparatus according to claim 18, further comprising:
a second conditioning cell that includes:
a second cathode side;
a second anode side;
a second cathode located on said second cathode side;
a second anode located on said second anode side;
a second inlet in fluid communication with said first cathode outlet so as to receive the cathode flow and designed and configured to provide the cathode flow to both said second cathode side and said second anode side to provide, respectively, a cathode-cathode flow and a cathode-anode flow;
a second cathode outlet designed and configured to allow the cathode-cathode flow to exit said second cathode side;
a second anode outlet designed and configured to allow the cathode-anode flow to exit said second anode side; and
a second ion-selective filter membrane separating the cathode-cathode flow and cathode-anode flow from one another, said second ion-selective filter membrane designed/configured/selected to, when the water is present and said second cathode and said second anode are energized:
permit the alkaline earth metal cations in the cathode-anode flow to pass to the cathode-cathode flow; and
inhibit the carbonate anions in the cathode-cathode flow from passing to the cathode-anode flow.

27. An apparatus according to claim 26, further comprising a reservoir in fluid communication with each of said first anode outlet and said second anode outlet so as to receive, respectively, the anode flow and the cathode-anode flow.

28. An apparatus according to claim 26, further comprising a precipitator in fluid communication with each of said first cathode outlet and said second cathode outlet so as to receive, respectively, the cathode flow and the cathode-cathode flow.

29. An apparatus according to claim 26, further comprising:
a third conditioning cell that includes:
a third cathode side;
a third anode side;
a third cathode located on said third cathode side;
a third anode located on said third anode side;
a third inlet in fluid communication with said second cathode outlet so as to receive the cathode-cathode flow and designed and configured to provide the cathode-cathode flow to both said third cathode side and said third anode side to provide, respectively, a cathode-cathode-cathode flow and a cathode-cathode-anode flow;
a third cathode outlet designed and configured to allow the cathode-cathode-cathode flow to exit said third cathode side;
a third anode outlet designed and configured to allow the cathode-cathode-anode flow to exit said third anode side; and
a third ion-selective filter membrane separating the cathode-cathode-cathode flow and the cathode-cathode-anode flow from one another, said second ion-selective filter membrane designed/configured/selected to, when the water is present and said third cathode and said third anode are energized:
permit the alkaline earth metal cations in the cathode-cathode-anode flow to pass to the cathode-cathode-cathode flow; and
inhibit the carbonate anions in the cathode-cathode-cathode flow from passing to the cathode-cathode-anode flow.

30. An apparatus according to claim 29, further comprising a reservoir in fluid communication with each of said first anode outlet, said second anode outlet, and said third anode outlet so as to receive, respectively, the anode flow, the cathode-anode flow, and the cathode-cathode-anode flow.

31. An apparatus according to claim 29, further comprising a precipitator in fluid communication with each of said first cathode outlet, said second cathode outlet, and said third cathode outlet so as to receive, respectively, the cathode flow, the cathode-cathode flow, and the cathode-cathode-cathode flow.

32. An apparatus according to claim 18, wherein the alkaline earth metal cations are calcium cations.

33. An apparatus according to claim 18, wherein the alkaline earth metal cations are magnesium cations.

34. An apparatus according to claim 18, further comprising a control system designed and configured to control a voltage applied to said cathode and said anode as a function of at least one of a conductivity and a pH of at least one of the cathode flow and the anode flow.

35. An apparatus according to claim 18, wherein said cathode and said anode have a spacing, the apparatus further comprising:
at least one electrode actuator designed and configured to move at least one of said cathode and said anode so as to change said spacing; and
a control system designed and configured to control said at least one electrode actuator so as to control said spacing of said cathode and said anode as a function of at least one of a conductivity and a pH of at least one of the cathode flow and the anode flow.
